(19) United States
(12) Patent Application Publication
(10) Pub. No.: US 2005/0036276 A1
(43) Pub. Date: Feb. 17, 2005

(54) Protective device for oblong bodies

(76) Inventor: Michael Lindner, Rosenheim (DE)

Correspondence Address: Pauley Petersen & Erickson;Suite 365, 2800 W. Higgins Road, Hoffman Estates, IL, 60195, US

(21) Appl. No.: 10/882,646

(22) Filed: Jul. 1, 2004

(30) Foreign Application Priority Data
Jul. 2, 2003 (DE) 103 29 857.6-34

(51) Int. Cl. H02B 1/00

(52) U.S. Cl. 361/600

(57) ABSTRACT

The invention relates to a protective device for oblong bodies, in particular for cable harnesses, cables, fuel, hydraulic, pneumatic or other lines, having a first inner protective layer, a second intermediate protective layer surrounding this first protective layer, and an outer protective layer, wherein the first protective layer is a cross-braided tube made of filament glass threads and aramid threads, and the intermediate protective layer is a knit of aramid, or aramid and metal fibers, and the outer protective layer is a knit of metal fibers, or metal fibers and aramid fibers.

### FIELD OF THE INVENTION

The invention relates to a protective device for oblong bodies, in particular for cable harnesses, cables, fuel lines, hydraulic lines, pneumatic lines, or other lines, having a first inner protective layer, a second intermediate protective layer surrounding this first protective layer, and an outer protective layer.

### BACKGROUND OF THE INVENTION

A protective sheathing for oblong flexible objects, in particular cables, with a multi-layered construction made of at least two pieces of formed fabric is known from EP 1 258 346 A2. This formed fabric can be constructed of the most differently formed fabrics, such as transverse, cross-formed, random-formed, mali-fleece, or similar formed fabrics. The formed fabrics are made, for example, of polyester, viscose or polypropylene, wherein this combination of two formed fabrics is said to provide a particularly good abrasion protection. Similar formed fabrics are also known from EP 1 063 747 A1. Such formed fabrics have proven themselves in their areas of application.

A thermal protection device for oblong bodies, zones of which are charged with heat from the outside, for example for lines in a motor vehicle, is known from WO 01/84685 A1, wherein at least one inner heat-resistant protective layer facing the body, as well as a medium which carries the heat away from the zones and distributes it over large areas, together form a known thermal protection device. This thermal protection device is built up of three layers in particular, wherein a Kevlar® tube can be arranged between the object to be protected and the first, inner heat-resistant protective layer facing the body, and a further protective layer is formed, which preferably rests against and surrounds the first protective layer, wherein the second protective layer can be made from a wire mesh.

It is furthermore generally known, for example in the field of motor vehicle manufacturing, to sheathe oblong bodies, for example hydraulic or pneumatic lines, or pneumatic tubes, or cable harnesses, with plastic corrugated tubes for protection against mechanical actions, in particular for protection against abrasion and against chafing. Customary corrugated tubes are made, for example, of polypropylene or polyamide, and can only be exposed to thermal stresses for a limited time, so that electrical conductors, tubes, or the like which are placed in the vicinity of heat sources in vehicles, for example near turbochargers, exhaust gas installations or the like, are not sufficiently protected against heat by such corrugated tubes. It is furthermore known to make highly temperature-resistant corrugated tubes from polytetrafluoroethylene (PTFE), or to embody the insulation of the conductor wires to be highly temperature-resistant, for example with a silicon or PTFE material. Moreover, it is known to form abrasion-protection devices made of filament glass fiber tubes in areas greatly exposed to high temperatures, however, these devices are not resistant to abrasive stresses.

With increasingly smaller structural spaces in the engine compartments of motor vehicles, some of the stresses placed on the protective devices are very complex (heat and/or abrasion and/or crushing and/or shearing and/or rattling), so that failures can no longer be ruled out. Moreover, in particular in connection with further reduced space in the front end of a motor vehicle, the problem increasingly arises that in case of accidents and the particularly strong deformations of the front end resulting therefrom, all components, i.e. all electrical, fuel, pneumatic or hydraulic lines are crushed or sheared off. Rerouting them so that such lines are not endangered by deformation becomes less and less possible.

In such accidents with correspondingly heavy deformation of the front end, electric lines or cables in particular are crushed, which results in accidental grounding in the area of the crushing or shearing because of defective insulation. Often the result of this is, in particular if fuel lines were also damaged by the same deformation, burning of the vehicle because of spark formation.

In connection with this, attempts have already been made to sheathe the cables as solidly as possible. However, these rigid protective devices or sheathings are undesirable during assembly and often result in rattles, and they are moreover not particularly temperature-resistant in most cases. It is known that aramid fibers have an excellent tensile strength and sufficient shear resistance. But it is disadvantageous that these fibers are not UV-resistant. Moreover, aramid fibers are only heat-resistant to 180° C. Although aramid fibers can be knit and braided, such tubes cannot be made round and therefore cannot be mounted in a reasonable way. Tests of tubes made using such fibers have been failures.

### SUMMARY OF THE INVENTION

It is an object of the invention to produce a protective device with great chafing and shearing resistance, with good properties over time at permanently high temperatures, which is easy to assemble.

The protective device in accordance with the invention has a triple-layered structure. The innermost protective layer arranged closest to the object to be protected includes a combination of filament glass fibers and aramid fibers.

Moreover, the first inner layer in accordance with the invention is cross-braided, wherein it was found in accordance with the invention that in contrast to ring braiding or spiral braiding, cross braiding results in a particularly homogeneous fiber distribution. The second layer includes knit aramid fibers or a combination knit of aramid and metal fibers, in particular aluminum and/or copper fibers. The third layer includes knit metal wire, or knit metal wires and aramid fibers, particularly when the second layer consists exclusively of aramid fibers.

The combination in accordance with the invention, wherein a first layer includes a combination cross-braiding of aramid fibers and filament glass fibers and the second layer is a knit layer of aramid fibers, results in good heat removal, as well as in outstanding shearing and crushing protection. Apparently a synergistic effect occurs here, because such a strong effect could not be obtained by means of a structure made of aramid fibers alone or filament glass fibers alone.

In what follows, the invention will be explained by means of an example represented in the drawings.

### BRIEF DESCRIPTION OF THE DRAWINGS

FIG. 1 shows the triple-layered structure of a protective device in a greatly schematic way.

FIG. 2 is a greatly schematized enlarged cross-section of a partial area of the first protective layer facing the object.

### DETAILED DESCRIPTION OF THE PREFERRED EMBODIMENTS

The protective device 1 for protecting an object 2 is an oblong tube embodied radially in three layers of a first inner layer 3, a second intermediate layer 4 and a third outer layer 5. The protective device 1 can extend over the entire object to be protected, or can be arranged over partial areas, in particular partial areas in which, besides high temperature stresses, a high shear stress can also be expected.

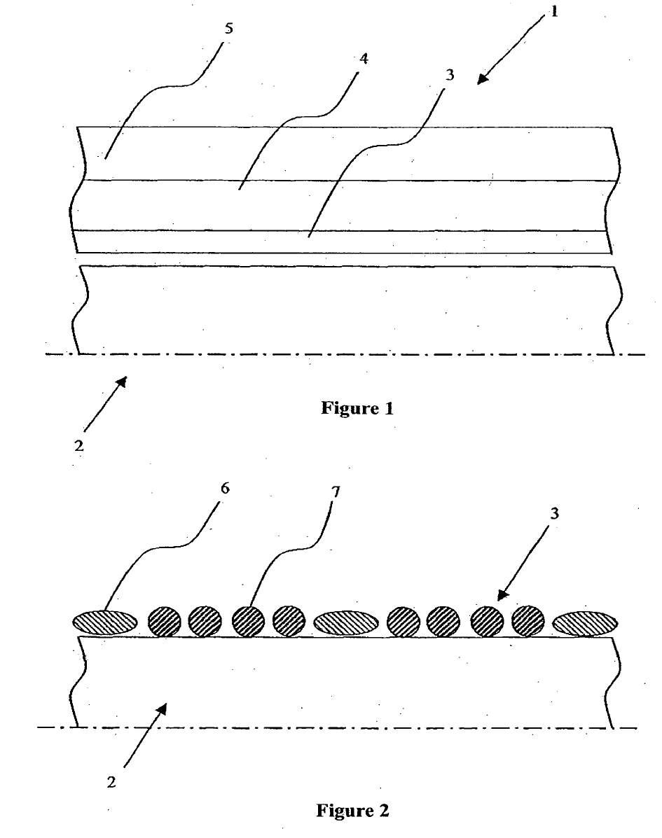

In one embodiment, the first inner layer 3 (FIGS. 1 and 2) is a braided tube body, wherein the braids are composed of filament glass threads 6 consisting of glass filaments and aramid threads 7 consisting of aramid filaments. The glass filaments can be made of E-glass, D-glass, R-glass or AR-glass, preferably of E-glass. The glass filaments of the filament glass thread 6 are made of E-glass of a density ρ of 2.6 g per cm³. Such glass filaments have a deformation point in the range between approximately 770° C. and 990° C., and E-glass filaments in particular at approximately 845° C. With otherwise unchanged material properties, such glass filaments have a thermal resistance up to approximately 350° C. (D-glass, R-glass, AR-glass), as well as up to approximately 300° C. (E-glass), and they did not show any loss of ultimate tensile strength up to temperatures of approximately 730° C. (D-glass, R-glass, AR-glass), or up to temperatures of approximately 600° C. (E-glass).

Such glass filaments have a relatively low thermal conductivity λ of approximately 0.8 to 1.2 W/mK, in particular 1.0 W/mK. The tensile strength of such filament glass threads 6 lies at approximately 2500 MPa, or 3400 MPa (E-glass). Filament glass made of the glass filaments mentioned is moreover fire-resistant and incombustible. For example, the glass filaments meet a specification of 68 Dtex 2.

The aramid threads 7 include a plurality of aramid filaments, which are twisted into a multi-filament. This is preferably a low-twist. The aramid fibers meet a specification of Dtex 1610, for example.

The filament glass threads 6 and the aramid threads 7 are cross-braided together. The advantage of cross braiding over round braiding or spiral braiding is a very good homogeneous fiber distribution of the combination of braided fiber components of glass and aramid. In this case the aramid portion of the combination cross-braided tube lies between 10% and 50%, preferably at 20% to 40%, and most preferred at 30%. In connection with the invention it was found that with combination cross braiding it is not only possible to achieve a very good homogeneous fiber distribution, but that such tubes can also be made round while having an aramid portion of up to 50%.

Moreover, in accordance with the invention it was also found that in connection with combination cross-braiding of the aramid fibers or threads 7 and the glass threads or fibers 6, the originally round fibers are radially crushed in the course of the combination braiding and during the rounding treatment with an impregnation and therefore assume a more flat cross-section. The protective surface and the protective effects can be clearly increased by this (FIG. 2).

For making it round, the first inner layer 3 is impregnated or lacquered, so that a mechanical bond between the filaments or the threads is formed and therefore the tube is given a permanent spatial shape which is rounded in cross-section and retains it during further treatment and processing.

Impregnations based on PTFE, silicon or polyurethane are suitable for impregnating the first layer, wherein the PTFE impregnation is temperature-resistant up to approximately 260° C., the silicon impregnation up to approximately 220° C., and the polyurethane impregnation up to approximately 155° C. An impregnation consisting of silicon resin is advantageously selected, since it was determined by means of the invention that the silicon resin impregnation results in a UV stabilization of the aramid fibers in the combination cross-braided tube. Moreover, the impregnation of the tube or of the first inner layer makes the handling of the tube easier, since the threads or filaments are held together at the cut ends of the tube by the impregnation and therefore unraveling at the ends of the tube is dependably prevented.

The second protective layer 4 is arranged, preferably in contact with and surrounding the first tube-shaped layer 3.

The second protective layer 4 is embodied as a knit layer of knit filaments. The knit consists of either aramid fibers or aramid fibers and metal wire filaments. The aramid fibers are preferably a multi-filament, which is also twisted, and low-twisted in particular, wherein the aramid fibers meet a specification Dtex 1610, for example. The metal wire filaments are formed of aluminum and/or copper and/or copper alloys, such as brass, tombac, and the like, and can be embodied as multi-filaments or monofilaments of a thickness of, for example, 0.08 mm to 0.2 mm, preferably 0.11 mm to 0.15 mm. If desired, the metal wire filaments can also be embodied from monel (NiCu₃OFe) and/or special steel. In connection with combination knitting, the aramid fiber and the wire can be knit in a single-flight and spirally circulating, so that loops are formed. The loops have a loop height H, also called loop length, in the range between 1.3 mm to 3 mm, in particular 1.7 mm to 2.3 mm, and have a loop distance, also called gauge, of 1 mm to 3 mm, in particular 1.4 mm to 1.7 mm. It is furthermore possible to produce the second protective layer by circular knitting of aramid fibers and metal wire in a double-flight spiral shape, wherein the respective loops made from wire are connected by means of the wire and the formation of free loops, wherein in the next round the free loops are again connected by means of the wire and while forming free loops. Double-flight knitting has the advantage that, in contrast to a single-flight knit tube body, after cutting off a tube body fashioned in this way, unintentional cutting open from the direction of a cut edge of the tube body is prevented.

This second protective layer is also preferably provided with an impregnation of the previously mentioned impregnating agents, preferably with a silicon resin impregnation. In this connection it is possible to first impregnate the first inner layer 3 and then to impregnate the second intermediate layer, or to knit the second layer around the first layer and then to impregnate both together.

The third protective layer 5, which is also produced as a knit, is designed to be in contact with and to surround the second intermediate protective layer. The knit of the outer layer 5 can be a metal wire knit or combination knit of metal wire filaments and aramid filaments. If the second layer consists exclusively of an aramid knit, the outer layer 5 is preferably embodied as a combination knit of metal wire filaments and aramid fibers. If the second intermediate layer 4 consists of a combination knit of metal wire filaments and aramid fibers, the third protective layer 5 preferably consists exclusively of metal wire filaments. The wire constituting the knit is preferably made of monel (NiCu₃OFe) and/or of special steel, in particular a special steel containing 12% to 18% chromium. If a metal wire is contained in the second intermediate layer, it is advantageous if the metal wire material of the outer protective layer 5 consists of a metal which, in the electrochemical series, is located close to the metal selected for the second protective layer 4, so that an electrochemical decomposition of the metal knits through the effects of moisture is avoided. For this reason, the metal wire knit of the outer layer 5 may be rendered sufficiently passive. The metal wire filaments of the outer layer 5 have a diameter of preferably 0.08 mm to 0.2 mm, and in particular of 0.11 mm to 0.15 mm. The aramid fibers, if used, meet a specification Dtex 1610, for example.

The loop width and the loop height of the outer layer 5 can be identical to those of the protective layer 4, however, it may be useful for the outer layer loops to be slightly greater or smaller, so that the protective layer 5 is securely seated outside of the protective layer 4 and the loops of the layers 4, 5 cannot become intermeshed, if possible. This provides that the loops of the protective layer 5 assuredly do not come into contact with a part of a chafing partner, so that they are not destroyed.

The third protective layer 5 is impregnated with any of the previously mentioned impregnation agents, wherein either first the first protective layer 3 is produced and then impregnated, then the second layer is applied around it and subsequently impregnated and then the third layer is applied and impregnated, or initially the first layer is produced and the second layer is applied around it, these are then impregnated together, then the third protective layer is applied and thereafter a final impregnation takes place. It has been found that merely the combination of a first cross-braided layer of aramid and filament glass with a second knit layer arranged around it provides a good heat dissipation, as well as good shearing protection.

The outer protective layer 5 which, in the form of a special steel knit, surrounds the knit of the second protective layer 4 is more resistant against mechanical effects, for example chafing, than a knit made of a light metal, for example aluminum alone. By means of sheathing the innermost protective layer 3 in two metal knits, a two-layered mesh cushion is formed which, in case of a chafing or punching stress, can resiliently give in the radial, as well as in the axial circumferential direction, so that therefore a chafing movement of the protective device in accordance with the invention against an adjacent structural component is reduced inside the mesh by the elastic deformation of the loops. In this connection it is of particular advantage that the combination of the inner layer 3 and the intermediate layer 4 moreover results in a previously-not-achieved, unknown, strong action against occurring shearing or crushing, wherein simultaneously the provision of a third layer made of a metal knit or metal and aramid knit assures the properties of the first protective layer 3 and the intermediate layer 4 even in case of the spot or planar appearance of strong temperature stresses. For example, battery cables today are compulsorily passed along highly temperature-stressed components, such as turbochargers or exhaust pipes, wherein in case of a deformation the cable is also crushed against these hot components, or is sheared by them. The tube in accordance with the invention is resistant even under these extraordinarily high stresses.

It lies of course within the scope of the invention to embody the described basic structure of a protection device 1 in several successive steps, so that an increased protection effect against shearing/crushing, as well as against thermal stress is achieved.

The metal wire filaments used in the various layers can be composed of a wide array of metals or alloys. In addition, a metal wire multi-filament can also be embodied in the form of individual threads or filaments made of different metals or alloys. The individual filaments and/or metal wire mono- or multi-filaments can be embodied to be passivated or insulated against each other. They are preferably made of monel (NiCu₃OFe) and/or special steel. Metal wire filaments are also suitable, which have been made in accordance with US Standard ASCN-B-520-93 (1998) from a so-called SCF material. Such layered metal wire filaments are destined for applications in electrical engineering, and there in particular for solving problems in the field of electrical or electromagnetic shielding. For example, such a layered wire, also called SCF wire, consists of 64% steel (core), 34% copper (intermediate surface) and 2% tin (outermost layer). Further wire embodiment types that are usable in connection with the invention are recited in the above-mentioned standard. The types of knitting in accordance with the invention can be embodied as single-thread single-flight, as well as double-threaded or double-flight, furthermore the knit can also be designed as a smooth knit, as well as a knit with oblique or arrow corrugations.

In connection with the embodiment of protective devices in accordance with the invention, it is of advantage that, along with a sufficiently good heat resistance or thermal shielding of a body to be protected, an outstanding resistance to crushing and/or shearing is achieved, so that structural components protected in this way have a very large crash or accident resistance at high deformation forces.

1. A protective device for oblong bodies, in particular for cable harnesses, cables, fuel, hydraulic, pneumatic or other lines, comprising:
an inner protective layer;
an intermediate protective layer surrounding the inner protective layer; and
an outer protective layer;
wherein the inner protective layer is a cross-braided tube comprising filament glass threads and aramid threads, the intermediate protective layer is a knit layer comprising aramid fibers, and the outer protective layer is a knit layer comprising metal fibers.

2. The protective device in accordance with claim 1, wherein the filament glass threads are mono- or multi-filaments, the multi-filaments being formed from a plurality of filament glass fibers;
the aramid threads are mono- or multi-filaments, the multi-filaments being formed from a plurality of aramid filaments; and
the metal fibers are mono- or multi-filaments.

3. The protective device in accordance with claim 1, wherein the aramid threads are multi-filaments made of aramid filaments that are low-twisted with each other, and the filament glass threads are multi-filaments formed from glass filaments of a relatively low heat conductivity λ of approximately 0.8 to 1.2 W/mK.

4. The protective device in accordance with claim 1, wherein the glass filaments are selected from the group consisting of E-glass, D-glass, R-glass and AR-glass, and the aramid threads consist of a plurality of aramid filaments that are twisted together and form a multi-filament.

5. The protective device in accordance with claim 1, wherein the filament glass threads meet a specification of 68 Dtex 2.

6. The protective device in accordance with claim 1, wherein the aramid threads meet a specification of Dtex 1610.

7. The protective device in accordance with claim 1, wherein the tensile strength of the glass threads lies between approximately 2500 MPa and 3400 MPa, and the filament glass threads are fire-resistant and incombustible.

8. The protective device in accordance with claim 1, wherein the inner protective layer comprises between 10 and 50% aramid threads.

9. The protective device in accordance with claim 1, wherein the aramid threads in the cross-braided tube have a radially flattened cross-section.

10. The protective device in accordance with claim 1, wherein the inner protective layer is impregnated or lacquered, which provides a mechanical bond between the filaments or threads, thereby providing the formed tube with a permanent spatial shape that is round in cross-section.

11. The protective device in accordance with claim 1, wherein the inner protective layer is impregnated with at least one of the group consisting of polytetrafluoroethylene, silicon, silicon resin, and polyurethane.

12. The protective device in accordance with claim 1, wherein the inner protective layer is impregnated with silicon resin to provide UV stabilization of the aramid threads.

13. The protective device in accordance with claim 1, wherein the intermediate protective layer is a knit layer of aramid fibers and metal fibers.

14. The protective device in accordance with claim 13, wherein the metal fibers comprise at least one of the group consisting of special steel, monel (NiCu₃OFe), aluminum, copper, copper alloys, brass, tombac, and an SCF material in accordance with US Standard ASCN-B-520-93 (1998).

15. The protective device in accordance with claim 13, wherein the metal fibers have a diameter between 0.08 mm and 0.2 mm.

16. The protective device in accordance with claim 13, wherein the metal fibers of the intermediate protective layer comprise at least one of the group consisting of aluminum, copper, copper alloys, brass, and tombac.

17. The protective device in accordance with claim 13, wherein the aramid fibers and the metal fibers are knit by a circular knitting process circulating in a single-flight spiral shape, or a double-flight spiral shape, such that loops are formed.

18. The protective device in accordance with claim 1, wherein the intermediate protective layer is impregnated with at least one of the group consisting of polytetrafluoroethylene, silicon, silicon resin, and polyurethane.

19. The protective device in accordance with claim 1, wherein the outer protective layer is in contact with and surrounds the intermediate protective layer, and is a knit layer comprising a combination of metal fibers and aramid threads.

20. The protective device in accordance with claim 1, wherein the intermediate layer consists essentially of a knit layer of aramid fibers, and the outer protective layer comprises a combination of metal fibers and aramid fibers,

21. The protective device in accordance with claim 1, wherein the intermediate layer comprises a knit layer of metal fibers and aramid fibers, and the outer protective layer consists essentially of metal fibers.

22. The protective device in accordance with claim 1, wherein the metal fibers of the outer protective layer comprise monel (NiCu₃OFe) and/or special steel containing 12% to 18% chromium.

23. The protective device in accordance with claim 1, wherein the intermediate layer further comprises metal fibers, and the metal fibers of the outer protective layer comprise a metal or an alloy which, in the electrochemical series, is located close enough to the metal in the intermediate protective layer to avoid electrochemical decomposition of the metal fibers from the effects of moisture.

24. The protective device in accordance with claim 1, wherein the outer protective layer and the intermediate protective layer each comprise a plurality of loops, and a loop width and a loop height of the loops in the outer protective layer is different than a loop width and a loop height of the loops in the intermediate protective layer.

25. The protective device in accordance with claim 1, wherein each of the knit layers comprises at least one knitting type selected from the group consisting of single-thread, single-flight, double-thread, and double-flight.
